(19) United States
(12) Patent Application Publication
(10) Pub. No.: US 2004/0201563 A1
(43) Pub. Date: Oct. 14, 2004

(54) Display apparatus

(75) Inventor: Hiroshi Kobayashi, Kanagawa (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Tokyo (JP)

(21) Appl. No.: 10/819,188

(22) Filed: Apr. 7, 2004

(30) Foreign Application Priority Data
Apr. 8, 2003 (JP) 2003-103766

(51) Int. Cl. G09G 3/36; G11B 5/09

(52) U.S. Cl. 345/100

(57) ABSTRACT

A configuration of a built-in feedback circuit of a display apparatus with a leftwardly and rightwardly reversing function is rationalized to achieve reduction of the number of devices and the power consumption. A horizontal driving circuit transfers a start pulse in response to a clock signal to successively generate sampling pulses to successively drive sampling switches so that an image signal is written into pixels. The feedback circuit detects a delay amount of each sampling pulse, which varies with time, and produces a feedback pulse. The phase of the clock signal to be inputted to a panel is adjustable outside the panel so as to compensate for the delay amount of the sampling pulse based on the feedback pulse. The horizontal driving circuit changes over transfer of the start pulse between forward transfer and reverse transfer in response to a changeover signal. The feedback circuit has a circuit configuration wherein overlapping elements used for both of the forward transfer and the reverse transfer are formed as common components used commonly.

### BACKGROUND OF THE INVENTION

This invention relates to an active matrix display apparatus of the dot-sequential driving type, and more particularly to a configuration of a feedback circuit incorporated in a panel of an active matrix display apparatus for compensating for a secular delay of a sampling pulse outputted from a horizontal driving circuit built in the display apparatus.

A conventional display apparatus typically has such a configuration as shown in FIG. 18. Referring to FIG. 18, the conventional display apparatus shown includes a panel 33 in which a pixel array section 15, a vertical driving circuit 16, a horizontal driving circuit 17, and other necessary circuits not shown are formed in an integrated manner. The pixel array section 15 includes gate lines 13 extending along rows, signal lines 12 extending along columns, and pixels 11 disposed in rows and columns at intersecting points of the gate lines 13 and the signal lines 12. The vertical driving circuit 16 is disposed divisionally on the opposite left and right sides of the pixel array section 15 and connected to the opposite ends of the gate lines 13 to successively select the rows of the pixels 11. The horizontal driving circuit 17 is connected to the signal lines 12 and operates in response to a clock signal of a predetermined period to successively write an image signal into the pixels 11 of the selected row. The conventional display apparatus further includes an external clock production circuit 18 generating clock signals HCK and HCKX, which are used as a reference to operation of the horizontal driving circuit 17, and clock signals DCK1 and DCK2 having an equal period to but having a lower duty ratio than those of the clock signals HCK and HCKX. It is to be noted that the clock signal HCKX is an inverted signal of the clock signal HCK. Further, though not described particularly herein, also inverted signals DCK1X and DCK2X of the clock signals DCK1 and DCK2 are supplied as occasion demands. The external clock production circuit 18 supplies the clock signals and a horizontal start pulse HST to the panel 33 side. It is to be noted that a precharge circuit 20 is connected to the signal lines 12 to perform precharge of the signal lines 12 preceding to writing of an image signal to improve the picture quality.

The conventional display apparatus shown in FIG. 18 is an active matrix display apparatus of the driving circuit built-in type, which uses polycrystalline silicon thin film transistors or like devices. A liquid crystal display apparatus and an organic EL display apparatus are representative ones of display apparatus of the type described. Where a liquid crystal display apparatus is used, for example, as a display apparatus in a VTR integrated with a camera or an information portable terminal, it is formed as a display apparatus including a horizontal driving circuit having a leftwardly and rightwardly reversing function, that is, a bidirectional horizontal driving circuit built therein in order to be ready for an application for displaying an image with a monitor section thereof turned or pivoted freely. In the conventional display apparatus shown in FIG. 18, the signal transfer direction of the horizontal driving circuit is changed over between a forward direction and a reverse direction with a changeover signal RGT supplied thereto from the outside.

FIG. 19 is a circuit diagram showing an example of a configuration of the display apparatus shown in FIG. 18. Referring to FIG. 19, the display apparatus is composed of a panel, which includes gate lines 13 extending along rows, signal lines 12 extending along columns, pixels 11 disposed in rows and columns at intersecting points of the gate lines 13 and the signal lines 12, and an image line 25 for supplying an image signal. The display apparatus includes a vertical driving circuit 16, a horizontal driving circuit 17, and a clock production circuit 18 in addition to the panel described above. Typically, the vertical driving circuit 16 and the horizontal driving circuit 17 are built in the panel. Also a sampling switch set 23 is formed in the panel. Each switch (HSW) of the sampling switch set 23 is disposed in a corresponding relationship to an individual one of the signal lines 12 and acts to connect the image line 25 to the signal line 12.

The vertical driving circuit 16 is connected to the gate lines 13 and sequentially selects the pixels 11 in a unit of a row. The horizontal driving circuit 17 operates in response to a clock signal of a predetermined period to successively generate sampling pulses A′, B′, C′, D′, . . . to successively drive the switches HSW of the sampling switch set 23 thereby to select a row of the pixels 11 into which an image signal is to be successively written.

The clock production circuit 18 produces a clock signal HCK, which is used as a reference to operation of the horizontal driving circuit 17, and produces clock signals DCK1 and DCK2 having a smaller pulse width than that of the clock signal HCK. Meanwhile, the horizontal driving circuit 17 includes a shift register 21 and an extracting switch set 22. It is to be noted that each of the stages of the shift register 21 is denoted by S/R. The shift register 21 performs a shifting operation of the horizontal start pulse HST in synchronism with the clock signal HCK to successively output shift pulses A, B, C, D, . . . from the successive shift stages S/R thereof. The switches of the extracting switch set 22 extract the clock signals DCK1 and DCK2 in response to the shift pulses A, B, C, D, . . . successively outputted from the shift register 21 to successively produce sampling pulses A′, B′, C′, D′, . . . described hereinabove.

Operation of the display apparatus shown in FIG. 19 is described briefly with reference to FIG. 20. The horizontal driving circuit 17 operates in response to the clock signal HCK (which may be hereinafter referred to suitably as HCK pulse) and the clock signal HCKX, which is an inverted signal of the clock signal HCK, to successively transfer the horizontal start pulse HST to produce shift pulses A, B, and C. The clock production circuit 18 supplies the HCK pulse and the clock signals DCK1 and DCK2 (which may be hereinafter referred to suitably as DCK pulses) to the horizontal driving circuit 17. As apparently seen from the timing chart of FIG. 20, while the DCK pulses have a period equal to that of the HCK pulse, the DCK pulses have a smaller pulse width than that of the HCK pulse. Further, the clock signals DCK1 and DCK2 have phases displaced by 180 degrees from each other.

The horizontal driving circuit 17 drives the extracting switch set 22 to open and close with the shift pulses A, B, and. C to extract DCK pulses. Then, the horizontal driving circuit 17 produces the sampling pulses A′, B′, and C′ from the extracted DCK pulses. More particularly, a pulse of the DCK pulse DCK1 is extracted with the shift pulse A to produce the sampling pulse A′. Similarly, a pulse of the DCK pulse DCK2 is extracted with the shift pulse B to produce the sampling pulse B′. Such a clock drive method as just described is employed so that mutually adjacent sampling pulses may not overlap with each other. In other words, the sampling pulses A′ and B′ are spaced from each other in time and do not overlap with each other at all. Also the sampling pulses B′ and C′ are spaced from each other in time and do not overlap with each other at all.

In the conventional active matrix display apparatus of the dot-sequential driving type, sampling pulses are successively supplied from the horizontal driving circuit to sample and hold an image signal to the signal lines. The horizontal driving circuit is usually formed from thin film transistors. When the panel is driven, a hot carrier stress occurs with the thin film transistors to increase a threshold voltage “Vth” of the thin film transistors. Therefore, the phase of the sampling pulses outputted from the horizontal driving circuit delays with time. When a sampling pulse for sample holding an image signal is delayed, the potential of the image signal to be sample held to a next signal line is sometimes taken in at the pertaining stage in error. This gives rise to appearance of an image, which should not be displayed originally, as a ghost on the screen.

In order to prevent a ghost, conventionally a feedback circuit is provided in a panel as disclosed, for example, in Japanese Patent Laid-open No. Hei 11-119746, Japanese Patent Laid-open No. 2000-298459, Japanese Patent Laid-open No. 2002-72987, and Japanese Patent Laid-open No. 2002-162928.

The feedback circuit produces, in order to detect a delay amount of a sampling pulse, which varies with time, a feedback pulse reflecting the delay amount and feeds back the feedback pulse from the inside of the panel to the outside. The phase of the clock signal to be inputted to the panel is adjusted externally based on the feedback pulse so as to compensate for the delay amount of the sampling pulse.

In the horizontal driving circuit having a leftwardly and rightwardly reversing function described above with reference to FIG. 18, it is necessary to produce the feedback pulse for both of the forward transfer and the reverse transfer. Therefore, in the conventional display apparatus, a system for detecting a delay of a sampling pulse upon forward transfer and another system for detecting a delay of a sampling-pulse upon reverse transfer are provided separately from each other, and the two systems are collected to a single system at the output stage. Accordingly, the feedback circuit requires a layout area and an increased number of devices for the two systems. The increased number of devices results in increased power consumption.

### SUMMARY OF THE INVENTION

It is an object of the present invention to provide a display apparatus with a leftwardly and rightwardly reversing function wherein a configuration of a built-in feedback circuit is rationalized to achieve reduction of the number of devices and the power consumption.

In order to attain the object described above, according to the present invention, there is provided a display apparatus, including a panel including a plurality of gate lines extending along rows, a plurality of signal lines extending along columns, a plurality of pixels arranged in a matrix at intersecting points at which the gate lines and the signal lines intersect with each other, and an image line for supplying an image signal, a vertical driving circuit disposed in the panel and connected to the gate lines for successively selecting the rows of the pixels, a plurality of sampling switches disposed in the panel for connecting the signal lines to the image line, a horizontal driving circuit operable in response to a clock signal inputted thereto from the outside for successively generating sampling pulses to successively drive the sampling switches so that the image signal is successively written into the pixels of the selected row, and a feedback circuit for detecting a delay amount of each of the sampling pulses, which varies with time and producing a feedback pulse on which the delay amount is reflected and then feeding back the feedback pulse from the inside to the outside of the panel. The phase of the clock signal to be inputted to the panel is adjustable outside the panel so as to compensate for the delay amount of the sampling pulse based on the feedback pulse. The horizontal driving circuit includes a shift register for receiving a start pulse and the clock signal from the outside and performing a shifting operation of the start pulse to successively output shift pulses from individual shift stages thereof and an extraction switch set for extracting the clock signal in response to the shift pulses successively outputted from the shift register to successively produce the sampling pulses. The shift register is capable of changing over transfer of the start pulse between forward transfer wherein the start pulse is transferred in a forward direction and reverse transfer wherein the start pulse is transferred in a reverse direction in response to a changeover signal supplied thereto from the outside. The feedback circuit has a circuit configuration wherein overlapping elements used for both of the forward transfer and the reverse transfer are formed as common components used commonly.

More particularly, the feedback circuit includes a single processing circuit similar to each shift stage of the shift register, a single extraction switch for extracting the clock signal with the start pulse having passed through the processing circuit to produce a feedback pulse, and a selector for selecting the phase of the clock signal to be supplied to the extraction switch in response to the changeover signal.

In the display apparatus, the configuration of the feedback circuit is rationalized to extrude overlapping elements for the forward transfer and the reverse transfer so that the common elements may be used commonly for the forward transfer and the reverse transfer as far as possible. More particularly, the feedback circuit includes a single processing circuit and a single extraction switch, which can be used commonly for the forward transfer and the reverse transfer. The single processing circuit has a configuration similar to a shift stage of the shift register. The single extraction switch extracts the clock signal with the start pulse having passed through the processing circuit to produce a feedback pulse. A selector is used to control the single extraction switch. The selector selects the phase of the clock signal to be supplied to the extraction switch in response to the changeover signal supplied thereto from the outside so that the feedback pulse may be outputted at a same timing upon both of the forward transfer and the reverse transfer.

In summary, the display apparatus has the built-in feedback circuit for canceling a ghost. The feedback circuit detects a delay amount of a sampling pulse in the inside of the panel in the dot-sequential active matrix display apparatus. An external IC corrects the sampling pulse based on the detected delay amount to suppress appearance of a ghost by an aging drift delay. In the present invention, the feedback circuit has a circuit configuration of the clock signal selection system in place of the conventional start pulse selection system, whereby the number of components of the feedback circuit can be reduced to substantially one half and reduction of the layout area and the power consumption can be achieved. In this instance, where the feedback circuit has a configuration same as that of a sampling pulse producing shift register for writing an image signal, it satisfies the demand as a delay monitor detection circuit for a sampling pulse in the inside of the panel.

### BRIEF DESCRIPTION OF THE DRAWINGS

These and other objects of the invention will be seen by reference to the description, taken in connection with the accompanying drawing, in which:

FIG. 1 is a circuit diagram showing a display apparatus to which the present invention is applied;

FIGS. 2 and 3 are timing charts illustrating operation of the display apparatus of FIG. 1;

FIG. 4 is a block diagram showing a basic configuration of a feedback circuit shown in FIG. 1;

FIG. 5 is a circuit diagram showing a shift register shown in FIG. 1;

FIG. 6 is a circuit diagram showing a more detailed configuration of the feedback circuit shown in FIG. 1;

FIG. 7 is a circuit diagram showing a display apparatus as a comparative example;

FIG. 8 is a circuit diagram showing a configuration of a feedback circuit built in the display apparatus of FIG. 7;

FIG. 9 is a block diagram showing a comparative example of a shift register having a leftwardly and rightwardly reversing function;

FIG. 10 is a circuit diagram showing a more detailed configuration of the shift register of FIG. 9;

FIG. 11 is a circuit diagram showing a typical example of a conventional display apparatus;

FIG. 12 is a diagrammatic view illustrating a cause of a ghost in the display apparatus of FIG. 11;

FIGS. 13A and 13B are timing charts illustrating an example of a conventional countermeasure against a ghost;

FIGS. 14A and 14B are diagrammatic views illustrating 12-phase XGA driving;

FIGS. 15A and 15B are diagrammatic views illustrating 6-phase XGA driving;

FIGS. 16A, 16B, and 16C and FIGS. 17A, 17B, and 17C are schematic views illustrating operation of the 6-phase XGA driving;

FIG. 18 is a block diagram showing an example of a conventional display apparatus;

FIG. 19 is a circuit diagram showing an example of a horizontal driving circuit built in the display apparatus of FIG. 18; and

FIG. 20 is a timing chart illustrating operation of the horizontal driving circuit of FIG. 19.

### DETAILED DESCRIPTION OF THE PREFERRED EMBODIMENTS

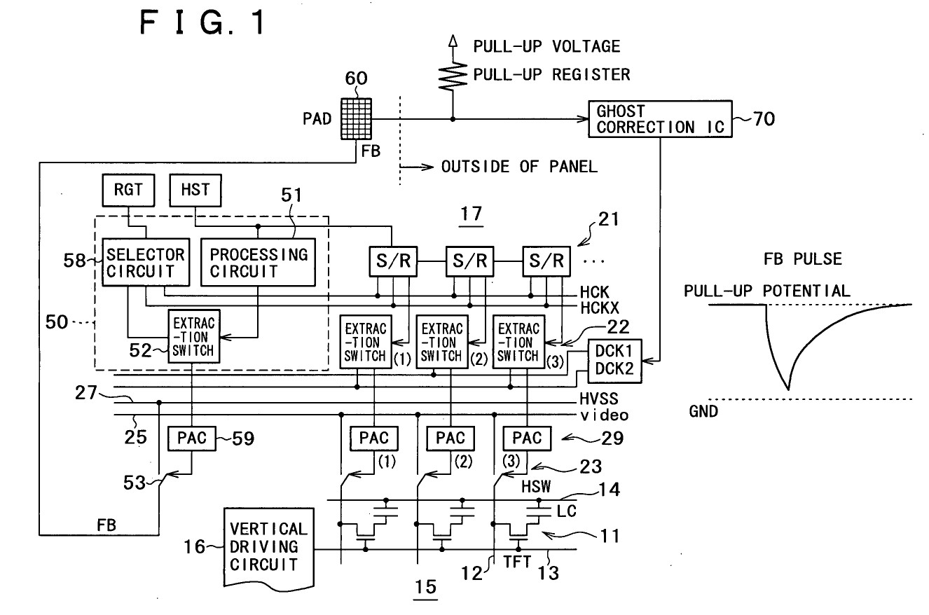

Referring to FIG. 1, there is shown a display apparatus to which the present invention is applied. The display apparatus shown is formed from a single panel and has a pixel array section 15, a vertical driving circuit 16, a horizontal driving circuit 17, a horizontal sampling switch set 23, a feedback circuit 50, and other necessary circuits built therein. The pixel array section 15 includes gate lines 13 extending along rows, signal lines 12 extending along columns, and pixels 11 disposed in rows and columns at intersecting points of the gate lines 13 and the signal lines 12. In the present embodiment, each of the pixels 11 includes a liquid crystal cell LC and a thin film transistor TFT. The liquid crystal cell LC is configured such that liquid crystal is sandwiched between an opposing electrode 14 and a pixel electrode. The drain electrode of the thin film transistor TFT is connected to the pixel electrode and the source electrode is connected to a signal line 12 while the gate electrode is connected to a gate line 13. The vertical driving circuit 16 is connected to the gate lines 13 extending along the rows to successively select the rows of the pixels 11. More particularly, the vertical driving circuit 16 successively outputs a selection pulse to render a thin film transistor TFT conducting to electrically connect the liquid crystal cell LC and a signal line 12 to select a row of the pixels 11. The sampling switch set 23 includes a plurality of sampling switches HSW and is disposed in the panel to connect the signal lines 12 of the columns to an image line 25. It is to be noted that the image line 25 is a wiring line for supplying an image signal “video” from the outside to the inside of the panel. The horizontal driving circuit 17 operates in response to clock signals HCK and HCKX inputted thereto from the outside to successively generate sampling pulses to successively drive the sampling switches HSW so that the image signal “video” is successively written into the pixels 11 of the selected row. The feedback circuit 50 produces, in order to detect a delay time of a sampling pulse, which varies with time, a feedback pulse FB reflecting the delay amount and feeds back the feedback pulse FB to an external ghost correction IC 70 from the inside of the panel through a terminal (PAD) 60. The external ghost correction IC externally adjusts the clock signals DCK1 and DCK2 to be inputted to the panel so as to compensate for the delay amount of the sampling pulse based on the feedback pulse FB.

The horizontal driving circuit 17 includes a shift register 21 formed from a plurality of shift stages (S/R) connected at multiple stages and an extraction switch set 22. The shift register 21 receives the start pulse HST and the clock signals HCK and HCKX from the outside and performs a shifting operation of the start pulse HST to successively output shift pulses (1) to (3) in FIG. 1 from the shift stages (S/R) thereof. The extraction switch set 22 extracts a clock signal DCK1 or DCK2 in response to the shift pulses (transfer pulses) successively outputted from the shift register 21 to successively produce sampling pulses (1) to (3) in FIG. 1. It is to be noted that the sampling pulses are applied to the sampling switches HSW of the sampling switch set 23 through a Phase Adjustment Circuit (PAC) 29. The phase adjustment circuit 29 performs phase adjustment of the clock signals DCK1 and DCK2 extracted by the extraction switch set 22. The clock signals DCK1 and DCK2 have phases basically displaced by 180 degrees from each other, and the phase adjustment circuit 29 absorbs an error, which may possibly appear between the clock signals DCK1 and DCK2.

The shift register 21 has a leftwardly and rightwardly reversing function and allows changeover between forward transfer wherein the start pulse HST is transferred in the forward direction and reverse transfer wherein the start pulse HST is transferred in the reverse direction in response to a changeover signal RGT supplied thereto from the outside. Meanwhile, the feedback circuit 50 has a circuit configuration wherein those components used commonly for the forward transfer and the reverse transfer are formed as common components, which are used commonly for the forward transfer and the reverse transfer. More particularly, the feedback circuit 50 includes a single processing circuit 51, a single extraction switch 52, and a selector circuit 58. The processing circuit-51 is similar in configuration to a shift stage S/R of the shift register 21. The extraction switch (CLK [clock signal] extraction) 52 extracts the clock signal HCK or HCKX with the start pulse HST having passed through the processing circuit 51 to produce a feedback pulse FB. The selector circuit 58 selects the phase of a clock signal to be supplied to the extraction switch 52 in response to the changeover signal RGT. In other words, the selector circuit 58 selects one of the clock signals HCK and HCKX in response to the changeover signal RGT. It is to be noted that the extraction switch 52 is substantially same in configuration as the switches of the extraction switch set 22 incorporated in the horizontal driving circuit 17. A pulse extracted by the extraction switch 52 is applied to a switch 53 through a phase adjustment circuit (PAC) 59. The phase adjustment circuit 59 has a same circuit configuration as that of the phase adjustment circuit 29. Also the switch 53 has a similar configuration to that of the sampling switches HSW of the sampling switch set 23. As a pulse having passed through the phase adjustment circuit 59 renders the switch 53 conducting, a ground potential HVSS supplied to a wiring line 27 is sampled and sent as a final feedback pulse FB to the terminal (PAD) 60.

As apparent from the foregoing description of the configuration, the feedback circuit 50 uses the processing circuit 51 commonly for both of the forward transfer and the reverse transfer. Also the extraction switch 52 is used commonly. The selector circuit 58 is provided to change over the processing circuit 51 and the extraction switch 52. Consequently, where the feedback circuit 50 is compared with a conventional feedback circuit, the number of components can be reduced substantially to one half. Accordingly, reduction in layout area can be achieved and also reduction of the power consumption can be achieved.

Further, in the display apparatus of the present embodiment, the feedback circuit 50 is provided at an end of the horizontal driving circuit 17 in order to detect a delay amount of a sampling pulse. It is to be noted that the feedback circuit 50 may otherwise be provided at the opposite ends of the horizontal driving circuit 17 under certain circumstances. The feedback circuit 50 extracts the clock signals HCK and HCKX as a pulse (FB pulse) for monitoring an internal delay of the panel in response to an input of the start pulse HST. It is to be noted that the IC may have such a system configuration that the clock signals DCK1 and DCK2, which are HSW sampling pulses, may otherwise be detected. This depends upon whether it is necessary to use an IC system configuration wherein initial values are invariable or another IC system configuration wherein initial values are variable. The extracted pulse passes through the phase adjustment circuit 59 similarly to an HSW sampling pulse and attacks at the gate of the switch 53. While a sampling switch HSW for a pixel samples the image signal “video” from the image line 25, the switch 53 for the feedback samples the ground potential HVSS supplied thereto from the wiring line 27. In particular, the switch 53 is held, when it is closed, at a predetermined pulled up potential outside the panel through the terminal (PAD) 60, but when the switch 53 is opened, it is pulled to the HVSS potential. A falling edge of the waveform upon the dropping to the ground potential is used as a final panel internal delay detection pulse (FB pulse). When the switch 53 is closed, a pull-up resistor (of a high resistance) outside the panel is referred to, but when the switch 53 is open, the HVSS resistor (which has a low resistance for laying of an aluminum wiring line) in the inside of the panel is referred to. Therefore, the transition is quicker with the waveform when the switch 53 is open, and the waveform can be used as a detection pulse (FB pulse). It is necessary for a feedback pulse for monitoring of an internal HSW sampling pulse delay to have a position, which does not vary depending upon whether the changeover signal RGT is RGT=HIGH (forward transfer) or RGT=LOW (reverse transfer). Therefore, it is necessary to use the changeover signal RGT to select whether the clock signal HCK should be extracted or the clock signal HCKX should be extracted. The present invention adopts a system wherein the selector circuit 58 selects the clock signal HCK or HCKX in response to the changeover signal RGT thereby to make it possible to use the processing circuit 51 and the extraction switch 52 commonly for the forward transfer and the reverse transfer. Thus, according to the present invention, the number of components can be reduced to approximately one half that of a conventional system. Consequently, reduction of the layout area and the power consumption can be achieved. Further, since the switch for extracting the clock signal HCK or HCKX is in an open state without fail when it is driven, a circuit configuration equivalent to that of a shift register can be used by estimating the resistance and the capacitance when the switch is on to design the buffer size for the clock signals HCK and HCKX. Consequently, a delay monitor detection circuit performance can be satisfied.

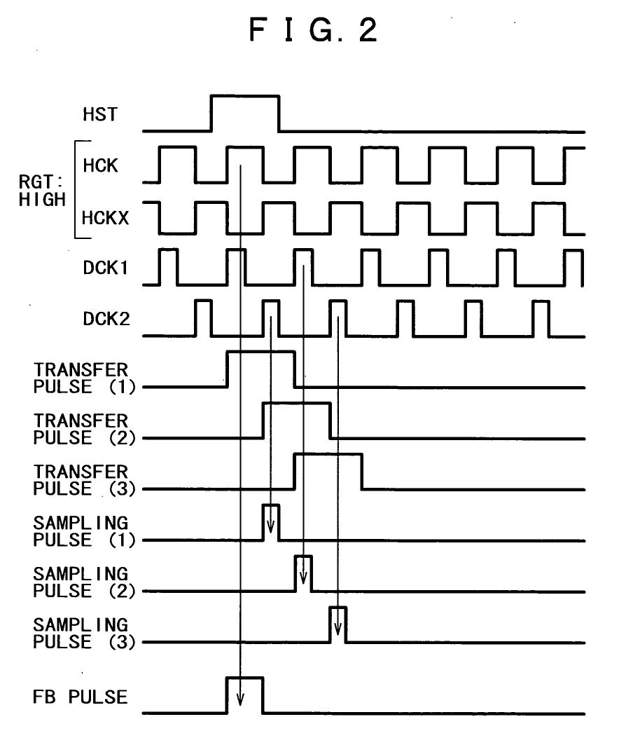

FIG. 2 is a timing chart illustrating operation of the display apparatus upon forward transfer. The changeover signal RGT has a level set to HIGH upon forward transfer. Consequently, the phase relationship between the start pulse HST and the clock signal HCK is determined in advance. It is to be noted that the clock signals HCK and HCKX have phases displaced by 180 degrees from each other. The period of the clock signal HCK is equal to the pulse width of the start pulse HST. On the other hand, while the clock signal DCK1 has a period equal to that of the clock signal HCK, it has a smaller pulse width than the clock signal HCK. The clock signal DCK2 has a phase displayed by 180 degrees from that of the clock signal DCK1. The shift register of the horizontal driving circuit operates in response to the clock signals HCK and HCKX to successively transfer the start pulse HST to successively output the shift pulses (transfer pulses) (1), (2), and (3). The first extraction switch on the horizontal driving circuit side extracts the clock signal DCK2 in response to the transfer pulse (1) to produce a sampling pulse (1). Similarly, the second extraction switch extracts the clock signal DCK1 in response to the transfer pulse (2) to produce a sampling pulse (2). Further, the third extraction switch extracts the clock signal DCK2 in response to the transfer pulse (3) to produce a sampling pulse (3). In this manner, the sampling pulses (1), (2), and (3) are outputted successively.

Meanwhile, on the feedback circuit side, the selector circuit 58 selects the clock signal HCK when RGT=HIGH. The extraction switch 52 on the feedback circuit 50 side extracts the selected clock signal HCK in response to the start pulse HST having passed through the processing circuit 51 and outputs an FB pulse. It is to be noted that the FB pulse illustrated in FIG. 2 is not of a final waveform outputted from the terminal (PAD) 60 but indicates an intermediate waveform applied to the gate of the switch 53.

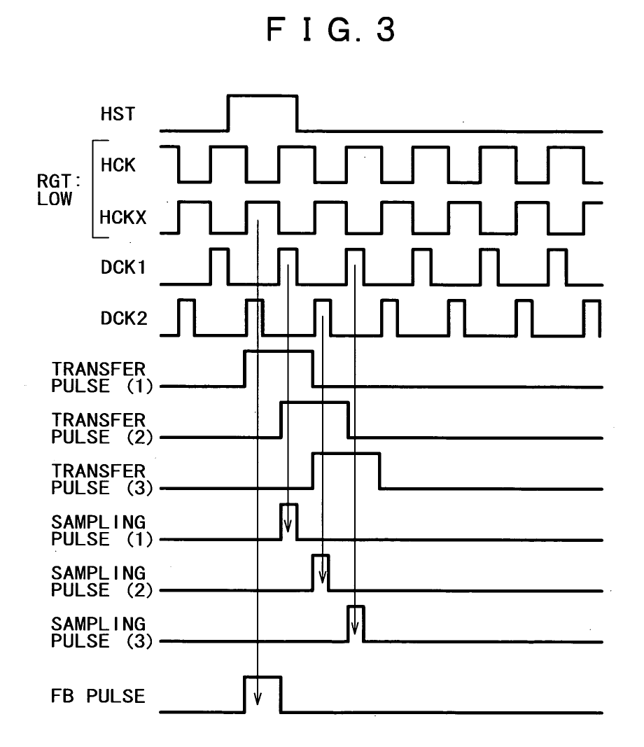

FIG. 3 is a timing chart illustrating operation of the display apparatus upon reverse transfer. In FIG. 3, in order to facilitate understanding, like elements to those of FIG. 2 are denoted by like reference characters. Upon reverse transfer, the changeover signal RGT is set to LOW. In response to the setting, a positional relationship between the start pulse HST and the clock signal HCK is set in advance. As can be seen apparently from the comparison between FIGS. 2 and 3, the phase relationship between the clock signal HCK and the start pulse HST is reversed. In response to this, the selector of the feedback circuit selects, where RGT=LOW, not the clock signal HCK but the clock signal HCKX. As can be seen apparently from the comparison between FIGS. 2 and 3, the phase of the clock signal HCK upon forward transfer and the phase of the clock signal HCKX upon reverse transfer coincide with each other. Upon reverse transfer, the selector circuit 58 selects the clock signal HCKX. The extraction switch 52 extracts the selected clock signal HCKX in response to the start pulse HST having passed through the processing circuit 51 to produce an FB pulse. As can be seen apparently from the comparison between FIGS. 2 and 3, the output timings of the FB pulse upon forward transfer and upon reverse transfer coincide with each other. By employing the configuration described, the processing circuit 51 and the extraction switch 52 in the feedback circuit 50 can be used commonly.

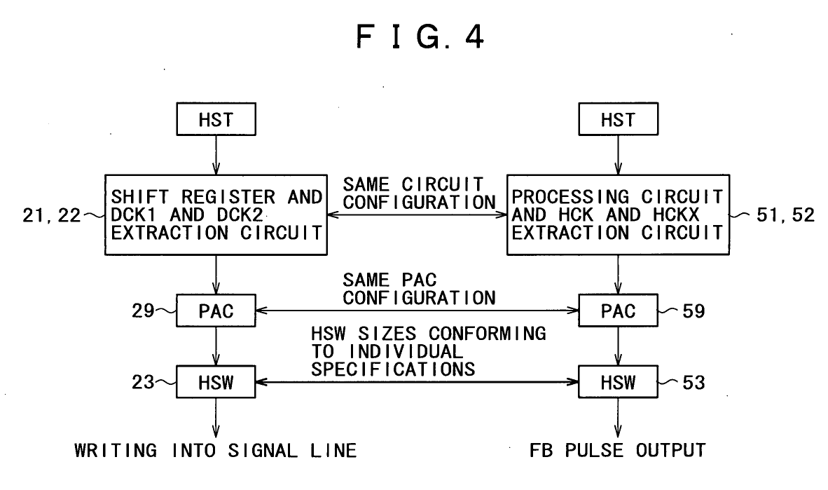

FIG. 4 is a flow diagram illustrating flows of signals in the feedback circuit and the horizontal circuit for comparison. Referring to FIG. 4, the feedback circuit shown on the right side monitors the horizontal driving circuit on the left side to detect a delay of a sampling timing with time. To this end, it is basically necessary for the monitoring portion of the feedback circuit to have a circuit configuration same as that of the horizontal driving circuit. The horizontal driving circuit side transfers the start pulse HST by means of the shift register 21 and extracts the clock signals DCK1 and DCK2 by means of the extraction switch set 22 to produce a sampling pulse. The sampling pulse drives a sampling switch HSW of the sampling switch set 23 to open and close through the phase adjustment circuit 29 to sample an image signal to the signal line. In a corresponding relationship to this, the feedback circuit side extracts the clock signals HCK and HCKX by means of the extraction switch 52 in response to the start pulse HST having passed through the processing circuit 51. The extracted pulse attacks on the gate of the switch 53 through the phase adjustment circuit 59 to output an FB pulse. Here, it is necessary for the shift register 21 and DCK1 and DCK2 extraction switch set 22 and the processing circuit 51 and HCK and HCKX extraction circuit 52 to have a same circuit configuration with each other. Also it is necessary for the phase adjustment circuit 29 and the phase adjustment circuit 59 to have a same circuit configuration. Furthermore, it is necessary for the sampling switches HSW of the sampling switch set 23 and the switch 53 to have transistor sizes in accordance with respective specifications.

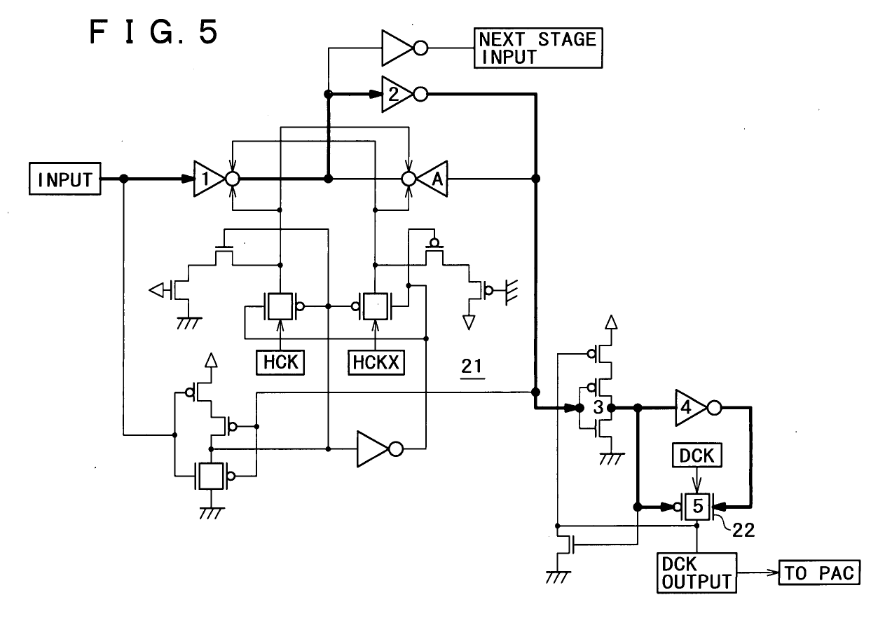

FIG. 5 is a circuit diagram showing a particular circuit configuration corresponding to one stage of the vertical driving circuit side. A start pulse transferred from the preceding stage is inputted to the pertaining stage, from which it is transferred to the succeeding stage with the clock signals HCK and HCKX. The pertaining stage S/R of the shift register 21 has a flip-flop configuration wherein it is clock-driven with the clock signals HCK and HCKX as seen in FIG. 5. The extraction switch of the extraction switch set 22 connected to the shift stage S/R of the shift register 21 is formed from a transmission gate. In the example shown in FIG. 5, the start pulse passes through an inverter 1, another inverter 2, a further inverter 3, and a still further inverter 4 and attacks on the gate of a transmission gate 5. The transmission gate 5, which is rendered conducting by the start pulse, extracts a clock signal DCK. The thus extracted clock signal DCK is sent to the Phase Adjustment Circuit (PAC).

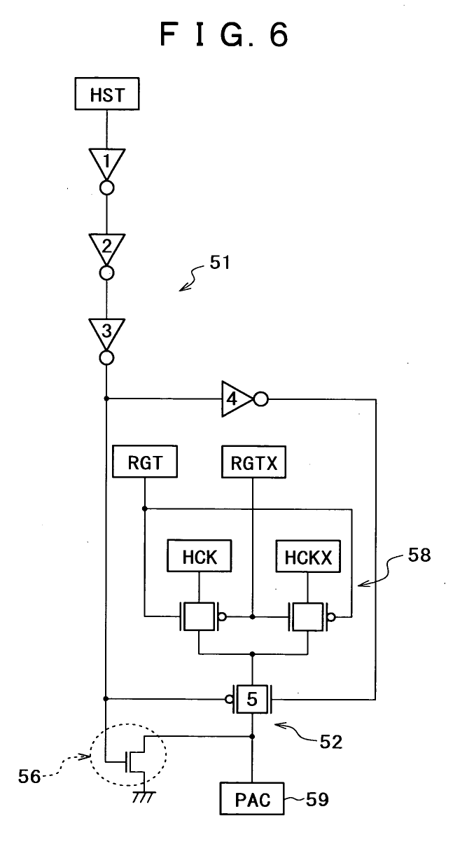

It is significant for the feedback circuit to have a configuration similar to that of the horizontal driving circuit side described hereinabove with reference to FIG. 5 and include transistors of the circuit elements, which have sizes equal to those of the horizontal driving circuit side, in order to make the characteristics the circuits each other. FIG. 6 is a circuit diagram showing a form of a feedback circuit formed in a matching state in this manner. In order to make the matching relationship clear, like elements in the configurations are denoted by like reference numerals in FIGS. 5 and 6. The processing circuit 51 includes inverters 1, 2, 3, and 4 and is equivalent to a shift stage (S/R) of the horizontal driving circuit side. Further, the CLK extraction circuit (extraction switch) 52 is formed from a transmission gate 5 and is same as the extraction switches of the extraction switch set 22 of the horizontal driving circuit side. A clock signal HCK or HCKX extracted by the extraction switch 52 passes through the phase adjustment circuit 59. It is to be noted that an uncertainty prevention circuit 56 for preventing uncertainty of an output potential is connected to an output terminal of the CLK extraction circuit 52. The selector circuit 58 is connected to the input side of the CLK extraction circuit 52 and selects the clock signal HCK or HCKX in response to the changeover signal RGT or RGTX.

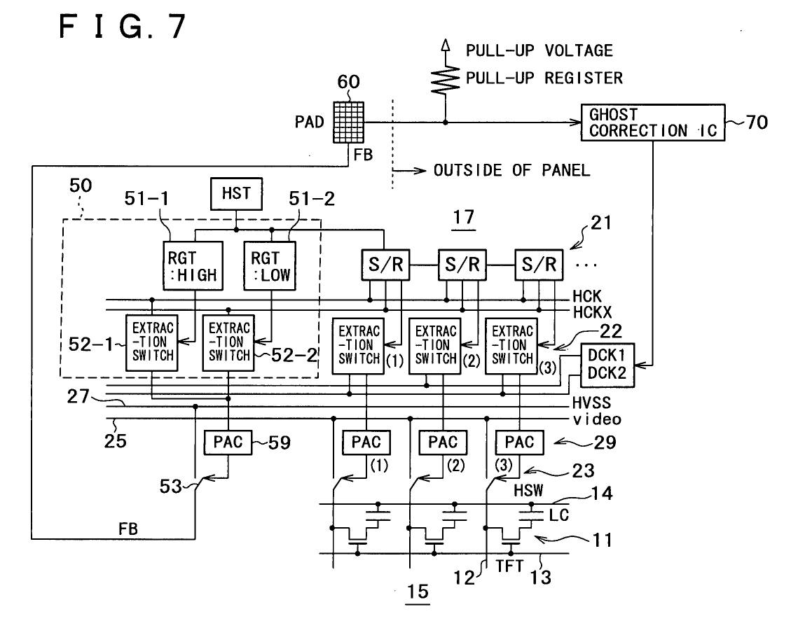

FIG. 7 is a schematic circuit diagram of a comparative example of a display apparatus. In FIG. 7, in order to facilitate understanding, like elements to those of the display apparatus of the present invention shown in FIG. 1 are denoted by like reference characters. Although the horizontal driving circuit has a basically same configuration, the feedback circuit 50 has a different configuration. In the comparative example, feedback circuit configurations of different systems are used for forward transfer and for reverse transfer. In particular, the comparative example includes, for the forward transfer, a processing circuit 51-1 having a same configuration as that of the shift stages S/R of the horizontal driving circuit and a CLK extraction circuit (extraction switch) 52-1 having a same configuration as that of the extraction switch set 22 of the horizontal driving circuit side. In addition, the comparative example includes a processing circuit 51-2 and a CLK extraction circuit 52-2 provided for the reverse transfer side. Pulses outputted from the two systems attack on the gate of the switch 53 through the phase adjustment circuit 59. A feedback pulse FB is formed finally by the switch 53 and sent to the terminal (PAD) 60.

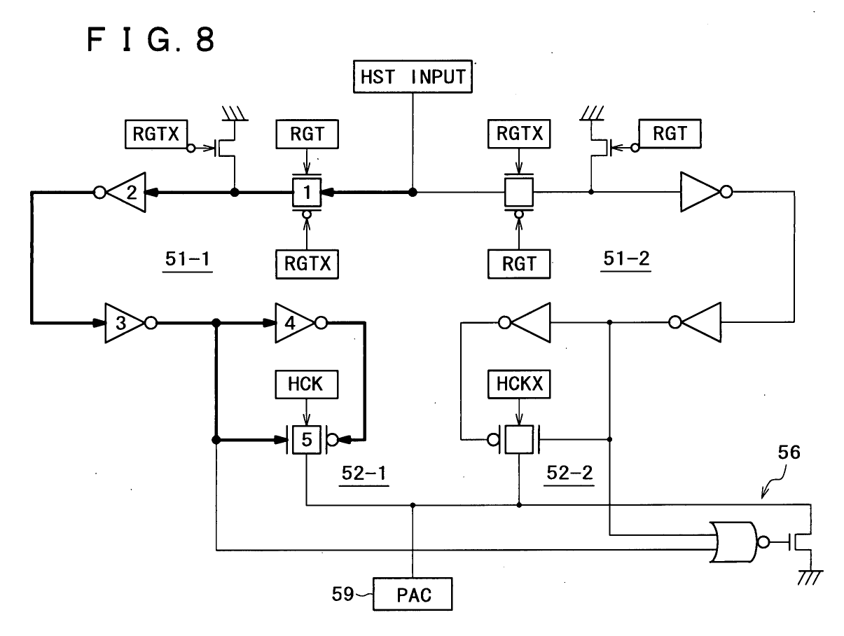

FIG. 8 is a circuit diagram showing a particular configuration example of the feedback circuit 50 shown in FIG. 7. Refer to FIG. 8, a CLK extraction circuit 52-1 is provided on the forward transfer side and includes a processing circuit 51-1 having a same configuration as that of the shift stage S/R of the horizontal driving circuit and a transmission gate 5. A processing circuit 51-2 and an extraction circuit 52-2 for the reverse transfer side are provided in a symmetrical relationship to the processing circuit 51-1 and the CLK extraction circuit 52-1, respectively. It is to be noted that, in order to prevent an uncertain state from appearing when HST=HIGH or LOW, an uncertainty prevention circuit 56 formed from a NOR gate element is additionally provided. As can be recognized apparently from the comparison between the feedback circuit of the present invention shown in FIG. 6 and the feedback circuit of the comparative example shown in FIG. 8, the latter requires a number of elements substantially equal to twice that of the former and is not preferable from the point of view of reduction of the layout area and the power consumption.

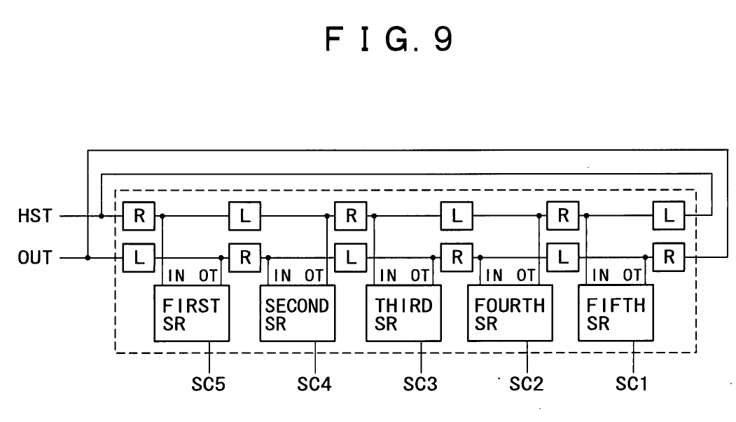

FIG. 9 is a circuit diagram showing a comparative example of a shift register having a leftwardly and rightwardly reversing function. As seen in FIG. 9, the shift register includes a plurality of shift stages (SR), a plurality of forward path gate elements L, and a plurality of reverse path gate elements R. A start pulse HST is inputted to the opposite ends of the shift register. Further, a detection signal OUT used for confirmation of operation of the shift register is outputted from the opposite ends of the shift register. Usually, in order to minimize input and output terminals for a panel, the signal wiring line for the start pulse HST and the signal wiring line for the detection signal OUT are connected to one side of the shift register.

Each of the shift stages SR of the shift register has an input terminal IN and an output terminal OT paired with each other, and the shift register has a multi-stage structure wherein the input and output terminals are connected successively. It is to be noted that the example shown in FIG. 9 has a five-stage connection wherein five shift stages SR are connected at first to fifth stages in order to facilitate understanding. In actual applications, there is no limitation to the number of stages. A reverse path gate element R is interposed in a connection path between the preceding stage side output terminal and the succeeding stage side input terminal of each adjacent preceding and succeeding ones of the shift stages SR, and a forward path gate elements L is interposed in another connection path between the succeeding side output terminal and the preceding side input terminal. For example, if the preceding stage side shift stage SR is referred to as first shift stage SR and the succeeding stage side shift stage SR is referred to as second shift stage SR in the multi-stage connection shown in FIG. 9, then a reverse path gate element R is interposed between the connection path between the output terminal OT of the first shift stage SR and the input terminal IN of the second shift stage SR. Further, a forward path gate element L is interposed between the connection path between the output terminal OT of the second shift stage SR and the input terminal IN of the first shift stage SR. If the reverse path gate element R and the forward path gate element L are controlled to open and close alternatively, then selective changeover can be performed between the forward signal transfer from the preceding state side to the succeeding stage side (in FIG. 9, signal transfer from the left side to the right side) and the forward signal transfer from the succeeding stage side to the preceding stage side (in FIG. 9, signal transfer from the right side to the left side).

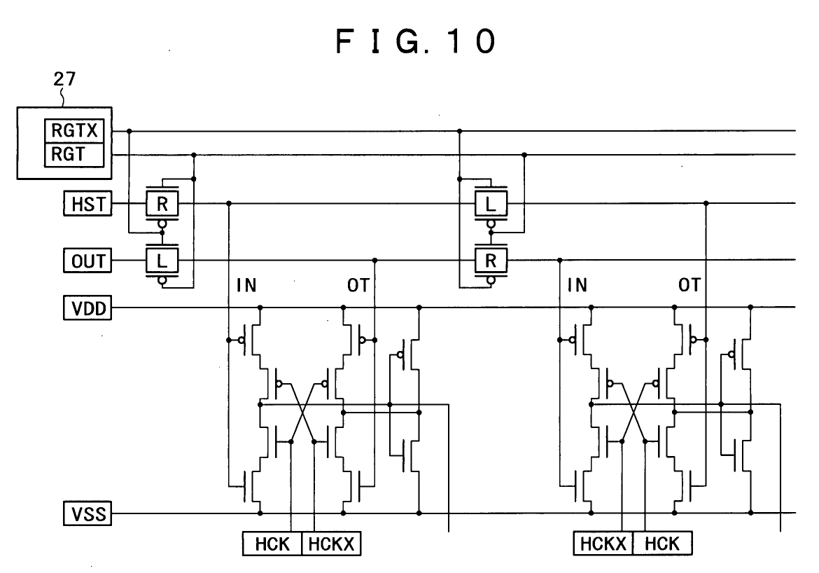

FIG. 10 is a circuit diagram showing an example of a more particular configuration of the shift register shown in FIG. 9. For the simplified illustration, only the first shift stage SR and the second shift stage SR as well as the reverse path gate elements R and the forward path gate elements L belonging to the first and second shift stages SR are shown. Each of the first shift stage SR and the second shift stage SR is formed from a D-type flip-flop and serves as a signal transmission block of the block control type. The D-type flip-flop is formed from first and second clocked inverters and a third inverter and operates in response to clock signals HCK and HCKX of phases opposite to each other to output a signal inputted from the input terminal IN to the output terminal OT after the flip-flop delays the signal by an amount equal to one half period of the clock signals. The reverse path gate elements R are formed from a transmission gate element of the CMOS type, and also the forward path gate elements L are formed from a transmission gate element similarly. The reverse path gate elements R and the forward path gate elements L are controlled by changeover signals RGT and RGTX of phases opposite to each other supplied thereto from the outside. When the changeover signal RGTX has the high level and the other changeover signal RGT has the low level, the reverse path gate elements R are opened while the forward path gate elements L are closed. Accordingly, at this time, the start pulse HST passes through the first reverse path gate element R and then is supplied to the input terminal IN of the first shift stage SR. The start pulse HST is delayed by an amount equal to one half period of the clock signals by the first shift stage SR and is then transferred from the output terminal OT of the first shift stage SR to the input terminal IN of the second shift stage SR through the reverse path gate element R. The start pulse HST is successively transferred in the reverse direction in this manner. On the other hand, when the changeover signal RGTX changes over to the high level and the changeover signal RGT changes over to the low level, the reverse path gate elements R are closed and the forward path gate elements L are opened. In this instance, a signal transferred in the forward direction is supplied to the input terminal IN of the second shift stage SR and delayed in a predetermined manner by the second shift stage SR, whereafter the signal is transferred from the output terminal OT of the second shift stage SR to the input terminal IN of the first shift stage SR through the forward path gate element L. Then, the signal is delayed in a predetermined manner by the first shift stage SR and outputted from the output terminal OT, and consequently, the signal is inputted to the next forward path gate element L.

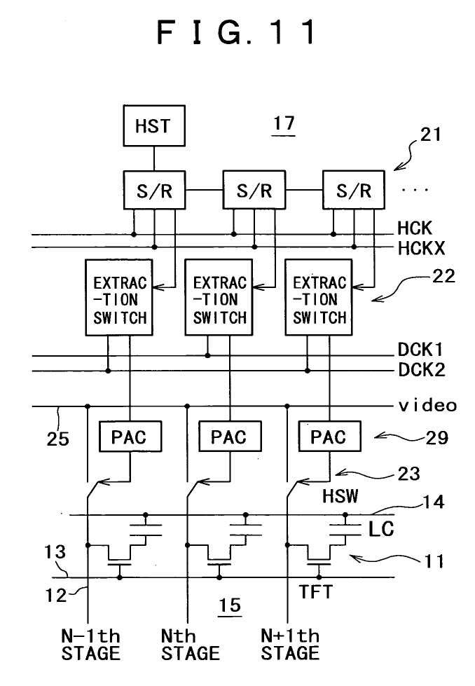

In order to allow the present invention to be recognized more particularly, a cause of a ghost and feedback control are described. FIG. 11 is a block diagram showing a typical configuration of a horizontal driving circuit. The horizontal driving circuit shown in FIG. 11 has a configuration basically same as that of the horizontal driving circuit shown in FIG. 1. However, the horizontal driving circuit of FIG. 11 includes no feedback circuit. Sampling pulses produced by the horizontal driving circuit 17 are successively applied to the sampling switches HSW of the sampling switch set 23, and an image signal “video” is successively sample held to the signal lines 12 of the N−1th, Nth, and N+1th stages.

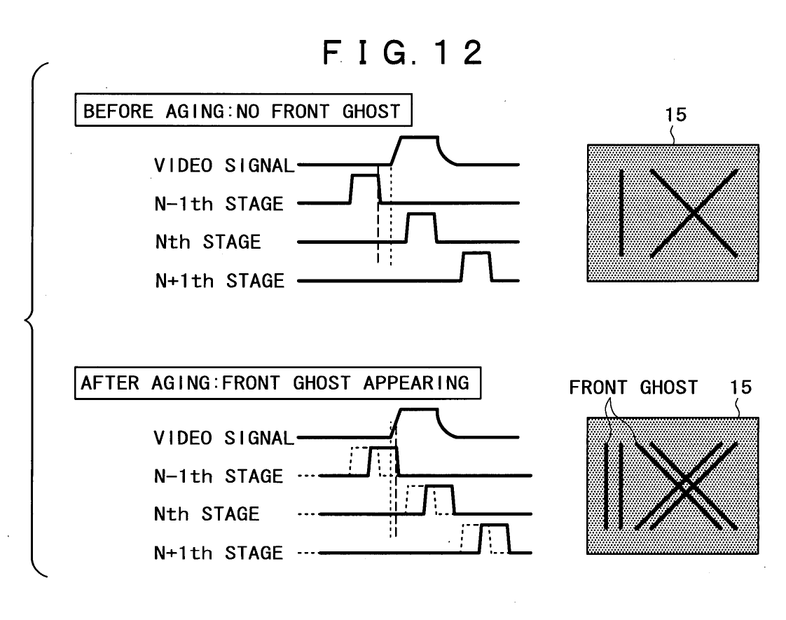

FIG. 12 is a diagrammatic view illustrating operation of the horizontal driving circuit shown in FIG. 11 and schematically illustrates a cause of appearance of a ghost. More particularly, FIG. 12 schematically illustrates a cause of appearance of a ghost when a peak of the dark level included in a video signal is written into a pixel column of the Nth stage. At an initial state (prior to aging), no delay of a sampling pulse occurs. Therefore, the dark level of the video signal can be sampled accurately with a sampling pulse of the Nth stage. Accordingly, no front ghost appears. In contrast, after aging, a delay occurs with a sampling pulse (drive pulse). Therefore, under certain circumstances, the peak of the dark level of the video signal is sometimes sampled partially with a drive pulse at the preceding stage (N−1th stage). In this instance, a front ghost appears. This aging effect is caused, for example, by a “Vth” shift by a hot carrier of a TFT. The delay width of a drive pulse by the aging effect is approximately 30 nsec. If the period of time of a delay amount permitted for a drive pulse after the initialization in which a state in which no ghost appears is established till a point of time before another state wherein a ghost appears due to a delay of a sampling pulse (drive pulse) is reached is defined as a ghost margin, then the margin to a front ghost is approximately 30 nsec. In the conventional XGA 12-dot simultaneous sampling driving, even if the non-overlapping time period is set to 30 nsec or more, which is a period of time corresponding to a pulse variation by aging, approximately 150 nsec can be assured for the sampling pulse width. However, in the 6-dot simultaneous driving, if the non-overlapping time period is set to approximately 30 nsec or more, which exceeds the ghost margin, then only approximately 30 to 45 nsec corresponding to a narrow pulse can be assured for the sampling pulse width. The pulse width of approximately 30 to 45 nsec is a region within which sampling period hoops are liable to occur.

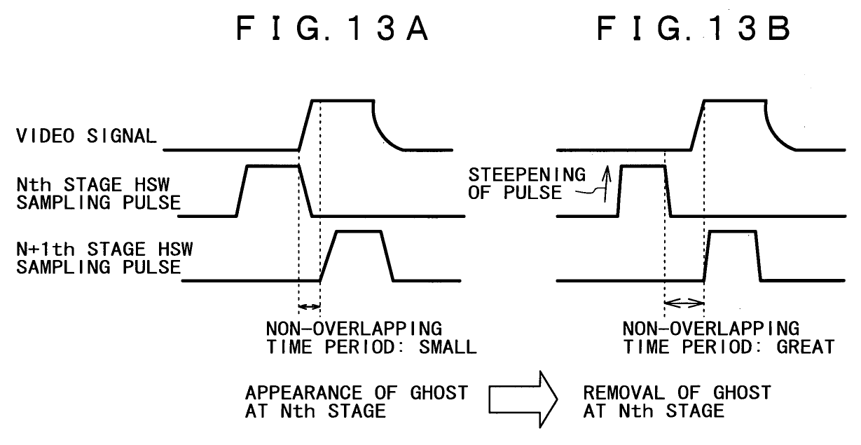

FIGS. 13A and 13B schematically illustrate an example of a countermeasure for expanding the ghost margin, and FIG. 13A illustrates waveforms before the countermeasure is taken while FIG. 13B illustrates waveforms after the countermeasure is taken. As seen from FIGS. 13A and 13B, in order to keep a sufficient ghost margin taking the delay amount of an HSW sampling pulse into consideration, a countermeasure is taken to steepen the HSW sampling pulse. Consequently, the non-overlapping time periods of the HSW sampling pulses at the preceding stage, pertaining stage, and succeeding stage are optimized. In other words, by shaping the sampling pulses to make them steeper, the non-overlapping time periods can be increased. Consequently, a ghost can be prevented to some degree.

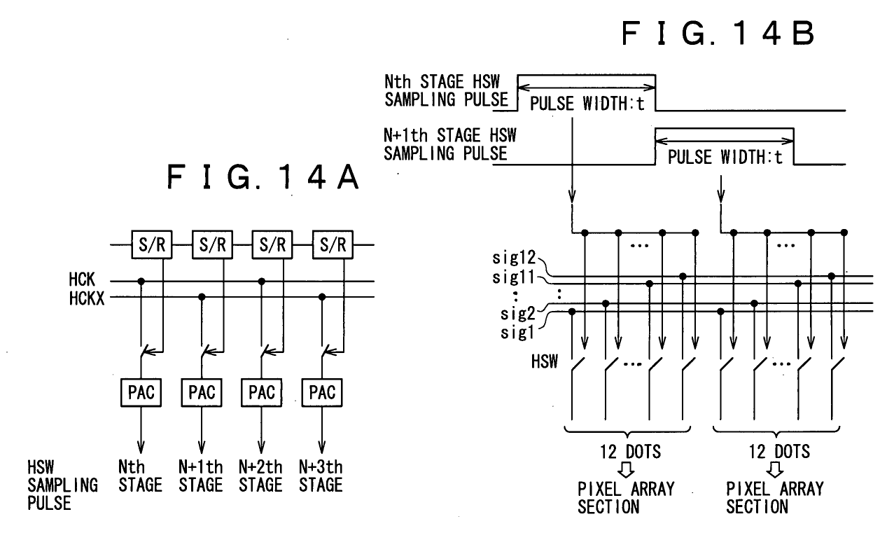

However, in order to promote the compatibility with the SVGA standards and reduce the system cost, a system wherein an XGA panel, which has conventionally been driven with 12 phases, is driven with 6 phases is becoming the main current at present. In the 6-phase driving XGA, it is necessary to raise the driving speed to twice that in the conventional 12-phase driving XGA, and this cannot be achieved only by the steepening of the sampling pulses described above. This is described below. FIGS. 14A and 14B schematically illustrate a conventional system called 12-dot simultaneous sampling system. As seen from FIG. 14A, the horizontal clocks HCK and HCKX are extracted with transfer pulses successively outputted from individual stages (S/R) of a shift register to produce sampling pulses for sampling switches HSW. The sampling pulses are successively applied to the sampling switches HSW of the Nth, N+1th, N+2th, and N+3th stages.

FIG. 14B illustrates a sampling pulse applied to the Nth stage sampling switch HSW and another sampling pulse applied to the N+1th stage sampling switch HSW. The sampling pulses have an equal pulse width t. An image signal of the XGA standards is supplied separately in 12 different phases (SIG1 to SIG12) from the outside through image lines. Conventionally, the 12-phase image signal is sent along image lines of one system. Accordingly, the 12-phase image signal is sampled to a set of 12 signal lines through respective sampling switches HSW. When a sampling pulse having the pulse width t is applied to the sampling switch HSW at the Nth stage, the signals SIG1 to SIG12 are sampled at a time and written into 12 pixels (dots) at a time. Accordingly, the system is called 12-bit simultaneous sampling. The XGA standards involve a greater number of pixels than the SVGA standards. The number of simultaneously written dots is increased as much to reduce the sampling frequency thereby to secure the sampling pulse width. In the conventional XGA 12-dot simultaneous sampling driving, even where the non-overlapping system is adopted, approximately 150 nsec can be assured for the sampling pulse width t. Therefore, even if the HSW sampling pulse width at an adjacent stage is displaced by an amount approximately equal to an actual capacity value of a polycrystalline silicon TFT (for example, displaced by approximately 2 nsec), the displacement does not appear as a great difference in the sampling hold potential, and a vertical stripe (sampling period hoop) corresponding to the sampling period does not appear on the screen. Further, due to improvement in uniformity, also the margin of a precharge signal supplied from the precharge circuit is as high as approximately 1.0 V with respect to a vertical stripe, and therefore, there is no problem.

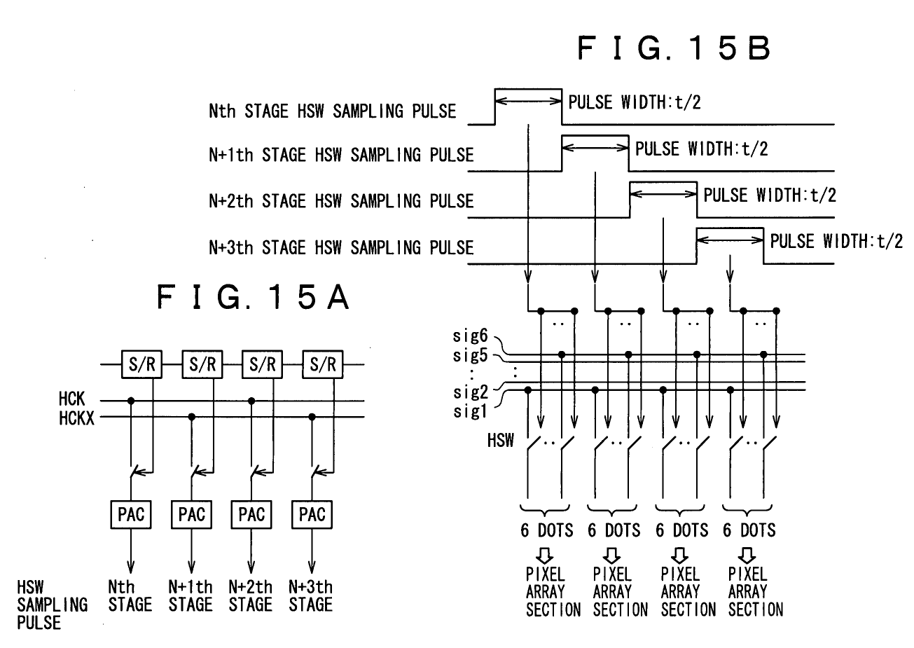

As the number of types of Liquid Crystal Display panels (LCD panels) increases, common use of a driving IC for both of the SVGA and XGA standards is proceeding. Thus, development of a technique for driving an XGA panel, which has conventionally been driven by the 12-dot simultaneous sampling system, by the 6-dot simultaneous sampling system same as that in the SVGA standards is proceeding. Consequently, although the 12-bit simultaneous sampling system requires two sample hold ICs for an image signal for each of panels for R, G, and B, the 6-dot simultaneous sampling method decreases the number of required sample hold ICs to one half, that is, to one for each of panels for R, G, and B, which reduces the cost. FIGS. 15A and 15B schematically illustrate the 6-dot simultaneous sampling system for an XGA panel. In FIGS. 15A and 15B, in order to facilitate understanding, like portions to those of the schematic views of the 12-dot simultaneous sampling system shown in FIGS. 14A and 14B are denoted by like reference characters. FIG. 15A schematically shows a sampling circuit and FIG. 15B is a timing chart of 6-dot simultaneous sampling. As apparently seen from contrast of the 6-dot simultaneous sampling of FIGS. 15A and 15B with the 12-dot simultaneous sampling of FIGS. 14A and 14B, the sampling pulses of the 6-dot simultaneous sampling driving have a pulse width equal to one half that of the 12-dot simultaneous sampling driving. Further, if the non-overlapping sampling driving is adopted as a countermeasure against a vertical stripe or in order to increase the ghost margin, then it is necessary to further reduce the sampling pulse width. Actually, the sampling pulse width becomes as narrow as approximately 30 to 45 nsec.

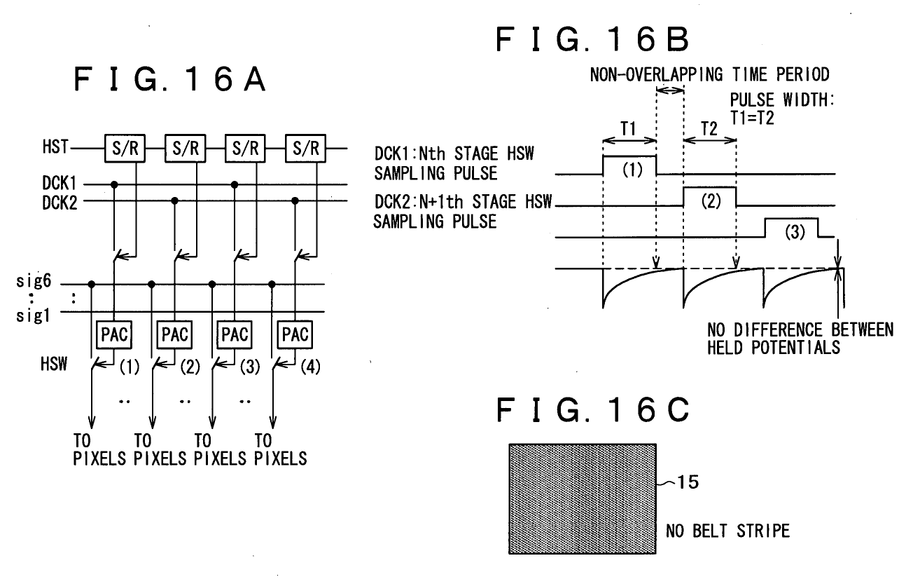

FIGS. 16A to 16C schematically show an operation of the non-overlapping driving of the 6-dot simultaneous sampling method. In FIGS. 16A to 16C, in order to facilitate understanding, like portions to those of the 6-dot simultaneous sampling system shown in FIGS. 15A and 15B where the non-overlapping method are not adopted are denoted by like reference characters. As seen in FIG. 16A, in the non-overlapping driving, the pulses DCK1 and DCK2 are extracted with transfer pulses successively outputted from the stages (S/R) of the shift register to produce sampling pulses (1), (2), (3), and (4). The sampling switches HSW operate to open and close in response to a sampling pulse to simultaneously sample six-phase image signals sig1 to sig6 and write the signals into corresponding pixels.

FIG. 16B is a timing chart illustrating the sampling pulses (1), (2), and (3). The sampling pulse (1) is produced by extracting the pulse DCK1 and has a pulse width T1. The sampling pulse (2) is produced by extracting the pulse DCK2 and has a pulse width T2. The pulses DCK1 and DCK2 have a basically equal pulse width although the phases thereof are displaced by 180 degrees from each other. Accordingly, the pulse widths T1 and T2 of the sampling pulses (1) and (2) have a relationship of T1=T2. It is to be noted that a predetermined non-overlapping period of time is interposed between the sampling pulses (1) and (2). In the state illustrated in FIG. 16B, since T1=T2, no potential difference appears between the held potentials of the image signal. Accordingly, a vertical stripe (sampling period hoop) does not appear on the pixel array section 15 shown in FIG. 16C.

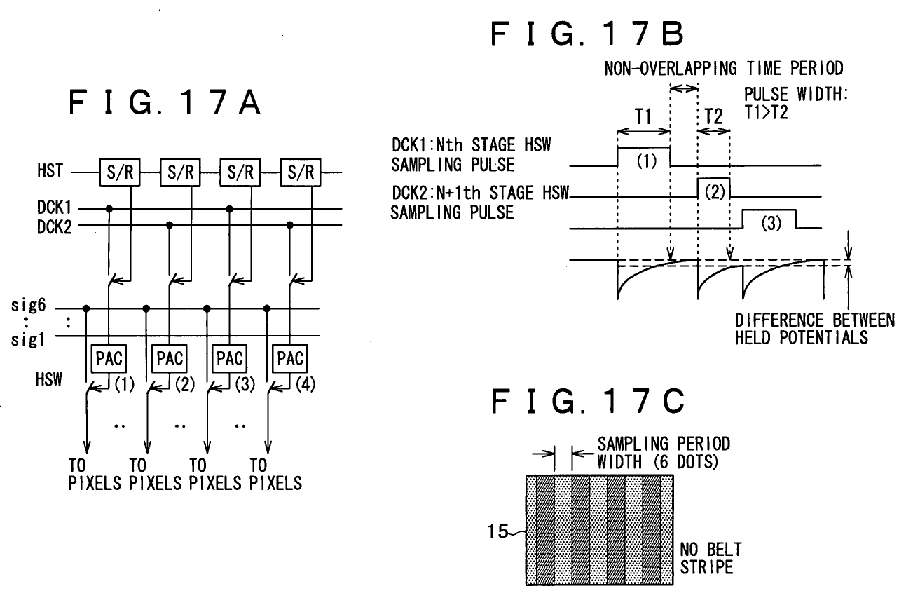

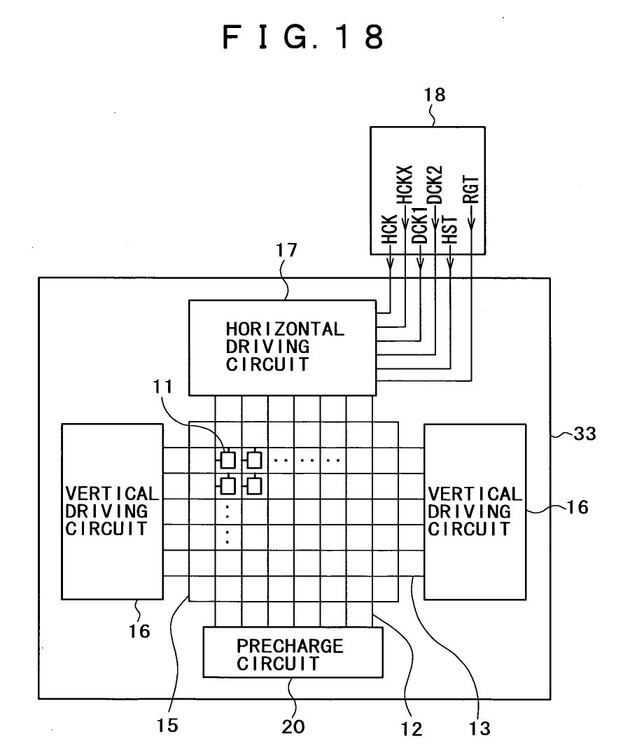

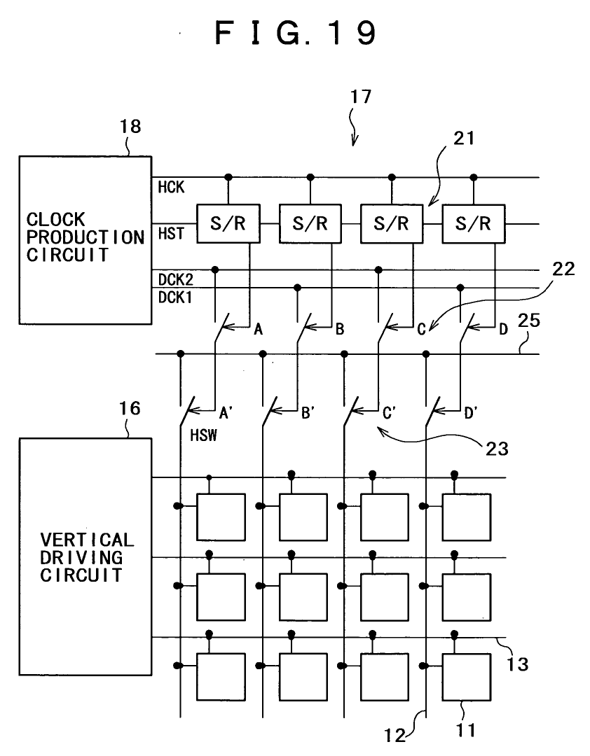

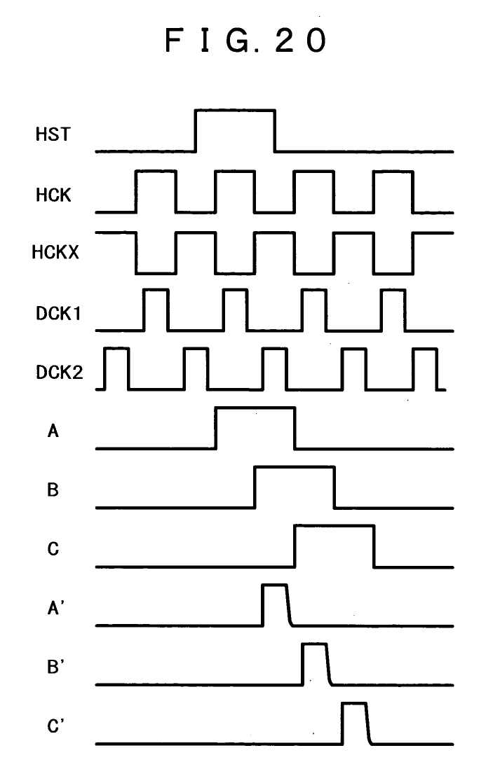

FIGS. 17A to 17C illustrate appearance of a displacement in duty ratio between the pulses DCK1 and DCK2. In FIGS. 17A to 17C, in order to facilitate understanding, like portions to those shown in FIGS. 16A to 16C where there is no displacement in duty ratio are denoted by like reference characters. If a displacement in duty ratio is present between the pulses DCK1 and DCK2 as seen in FIG. 17B, then an error appears between the pulse width T1 of the sampling pulse (1) and the pulse width T2 of the sampling pulse (2). Consequently, a difference appears between the potentials (held potentials) of the video signal sample held with the sampling pulses (1) and (2). As a result, hoops appear with a width of the sampling period (6 dots) on the pixel array section 15 as seen in FIG. 17C. As described hereinabove, if a non-overlapping period of time is taken in the 6-dot simultaneous driving system, then the sampling pulse becomes a narrow pulse of approximately 30 to 45 nsec. Since the pulse width is small, a displacement in duty by approximately 2 nsec conspicuously appears as a displacement in held potentials. Therefore, the margin of the precharge signal decreases to approximately 0.2 V, and consequently, sampling period hoops are liable to occur.

As apparent from the foregoing description, in the 6-phase driving XGA, a sufficient non-overlapping time period with an adjacent stage cannot be assured, and the ghost margin is very small. Therefore, a ghost feedback system is required wherein a delay amount of an HSW sampling pulse in the inside of a panel is detected and corrected by an IC provided outside the panel. According to the present invention, a feedback circuit ready for reduction of the power consumption, which includes a number of components reduced approximately to one half that of a conventional ghost feedback circuit, can be implemented.

While preferred embodiments of the present invention have been described using specific terms, such description is for illustrative purposes only, and it is to be understood that changes and variations may be made without departing from the spirit or scope of the following claims.

What is claimed is:

1. A display apparatus, comprising:
a panel including a plurality of gate lines extending along rows, a plurality of signal lines extending along columns, a plurality of pixels arranged in a matrix at intersecting points at which said gate lines and said signal lines intersect with each other, and an image line for supplying an image signal;
a vertical driving circuit disposed in said panel and connected to said gate lines for successively selecting the rows of said pixels;
a plurality of sampling switches disposed in said panel for connecting said signal lines to said image line;
a horizontal driving circuit operable in response to a clock signal inputted from the outside for successively generating sampling pulses to successively drive said sampling switches so that the image signal is successively written into the pixels of the selected row; and
a feedback circuit for detecting a delay amount of each of the sampling pulses, which varies with time, and producing a feedback pulse on which the delay amount is reflected and then feeding back the feedback pulse from the inside to the outside of said panel;
the phase of the clock signal to be inputted to said panel being adjustable outside said panel so as to compensate for the delay amount of the sampling pulse based on the feedback pulse;
said horizontal driving circuit including a shift register for receiving a start pulse and the clock signal from the outside and performing a shifting operation of the start pulse to successively output shift pulses from individual shift stages and an extraction switch set for extracting the clock signal in response to the shift pulses successively outputted from said shift register to successively produce the sampling pulses;
said shift register being capable of changing over transfer of the start pulse between forward transfer wherein the start pulse is transferred in a forward direction and reverse transfer wherein the start pulse is transferred in a reverse direction in response to a changeover signal supplied from the outside;
said feedback circuit having a circuit configuration wherein overlapping elements used for both of the forward transfer and the reverse transfer are formed as common components used commonly.

2. The display apparatus according to claim 1, wherein said feedback circuit includes a single processing circuit similar to each shift stage of said shift register, a single extraction switch for extracting the clock signal with the start pulse having passed through said processing circuit to produce a feedback pulse, and a selector for selecting the phase of the clock signal to be supplied to said extraction switch in response to the changeover signal.
